(19) United States
(12) Patent Application Publication
(10) Pub. No.: US 2007/0233806 A1
(43) Pub. Date: Oct. 4, 2007

(54) Method and system for conducting an internet search using a mobile radio terminal

(76) Inventor: Mehrzad Asadi, Cary, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/392,121

(22) Filed: Mar. 29, 2006

(51) Int. Cl. G06F 15/16

(52) U.S. Cl. 709/217

(57) ABSTRACT

A mobile radio terminal, a message center and an Internet server are configured to allow a user of the mobile radio terminal to conduct an Internet search and view search results without subscribing to an Internet service offered by a communications service provider. The Internet search is conducted using an exchange of text or multimedia messages.

### TECHNICAL FIELD OF THE INVENTION

The present invention relates generally to electronic equipment, such as mobile electronic equipment for engaging in voice communications. More particularly, the invention relates to a method and system for conducting an Internet search using a mobile radio terminal where the mobile radio terminal does not subscribe to an Internet service offered by a communications service provider.

### DESCRIPTION OF THE RELATED ART

Mobile and/or wireless items of electronic equipment are becoming increasingly popular. For example, mobile telephones are now in wide-spread use. In addition, the features associated with certain types of electronic equipment have become increasingly diverse. To name a few examples, many electronic equipment include cameras, text messaging capability, electronic mail capability, video playback capability, audio playback capability, image display capability and hands-free headset interfaces.

Some portable items of electronic equipment may include Internet browsing functionality. In order to conduct an Internet search using a mobile device, the user may launch an Internet web browser to interact with an Internet server that forms part of a communications network and that provides communication services to the mobile telephone. The Internet server may be a wireless application protocol (WAP) server. However, to access the Internet service available over the communications network, an Internet service option must be added to a subscription for communications services purchased from a service provider that operates the communications network. For instance, a user may subscribe with the service provider to place and receive calls using his or her mobile telephone. Typically, Internet service incurs an additional fee added to a basic monthly subscription rate or is included in a premium package of services that costs more than basic telephone service.

It is contemplated that many subscribers of mobile communication services do not add Internet services to their subscriptions since the frequency of use and/or need for such a service does not justify the added cost. Accordingly, these users are left without Internet service and there is an under-utilization of WAP Internet servers.

### SUMMARY

Aspects of the present invention are directed to allowing a user to conduct an Internet search and view search results without subscribing to an Internet service offered by a communications service provider. The Internet search according to aspects of the invention may be conducted using an exchange of text or multimedia messages.

According to one aspect of the invention, a method of searching the Internet using a mobile radio terminal includes transmitting a text or multimedia message containing a search query to a server of a communication network providing communication services to the mobile radio terminal; receiving one or more text or multimedia messages containing the identity of Internet sites satisfying the search query; selecting one of the identified Internet sites and transmitting a text or multimedia message containing a request for content from the selected Internet site to the server; and receiving one or more text or multimedia messages containing content from the selected Internet site.

According to another aspect, the method further includes displaying the Internet sites satisfying the search query as selectable links.

According to another aspect, the method further includes reassembling the content of the selected Internet site and displaying the content for viewing.

According to another aspect, at least one of the search query or the request is sent in a short message service format message.

According to another aspect, the identity of Internet sites satisfying the search query is received in one or more short message service format messages.

According to another aspect, the content is received in one or more multimedia messaging service format messages.

According to another aspect, the content is received in one or more short message service format messages.

According to another aspect of the invention, a program stored on a machine usable medium includes an Internet search function executable by a mobile radio terminal. The program includes executable logic to transmit a text or multimedia message containing a search query to a server of a communication network providing communication services to the mobile radio terminal; receive one or more text or multimedia messages containing the identity of Internet sites satisfying the search query; select one of the identified Internet sites and transmit a text or multimedia message containing a request for content from the selected Internet site to the server; and receive one or more text or multimedia messages containing content from the selected Internet site.

According to another aspect, the program further includes executable logic to display the Internet sites satisfying the search query as selectable links.

According to another aspect, the program further includes executable code to reassemble the content of the selected Internet site and display the content for viewing.

According to another aspect of the invention, a mobile radio terminal includes a radio circuit for exchanging data with a communications network and a processor. The process executes logic to transmit a text or multimedia message containing a search query to a server of the communication network providing communication services to the mobile radio terminal; receive one or more text or multimedia messages containing the identity of Internet sites satisfying the search query; select one of the identified Internet sites and transmit a text or multimedia message containing a request for content from the selected Internet site to the server; and receive one or more text or multimedia messages containing content from the selected Internet site.

According to another aspect, the processor of the mobile radio terminal further executes logic to drive a display with the Internet sites satisfying the search query as selectable links.

According to another aspect, the process of the mobile radio terminal further executes logic to reassemble the content of the selected Internet site and drive a display with the content.

According to another aspect of the invention, a method of retrieving content from a particular Internet site using a mobile radio terminal includes transmitting a text or multimedia message containing a request for the content to a server of a communication network providing communication services to the mobile radio terminal; and receiving one or more text or multimedia messages containing content from the selected Internet site.

According to another aspect of the invention, a method of providing Internet search support services to a mobile radio terminal includes receiving a text or multimedia message containing a search query from the mobile radio terminal; transmitting one or more text or multimedia messages containing the identity of Internet sites satisfying the search query to the mobile radio terminal; receiving a text or multimedia message containing a request for content from a selected one of the identified Internet sites from the mobile radio terminal; and transmitting one or more text or multimedia messages containing content from the selected Internet site to the mobile radio terminal.

According to another aspect, the method further includes forwarding the search query to an Internet server that carries out processing of the search query and returns the identity of the Internet sites satisfying the search query.

According to another aspect, the method further includes reformatting the content from a native format to a text or multimedia message format before transmission to the mobile radio terminal.

According to another aspect of the invention, a communications network server is configured to provide Internet search support services to a mobile radio terminal. The sever includes a processor that executes logic to receive a text or multimedia message containing a search query from the mobile radio terminal; transmit one or more text or multimedia messages containing the identity of Internet sites satisfying the search query to the mobile radio terminal; receive a text or multimedia message containing a request for content from a selected one of the identified Internet sites from the mobile radio terminal; and transmit one or more text or multimedia messages containing content from the selected Internet site to the mobile radio terminal.

According to another aspect, the processor of the communications network server further executes logic to forward the search query to an Internet server that carries out processing of the search query and returns the identity of the Internet sites satisfying the search query.

According to another aspect, the processor of the communications network server further executes logic to reformat the content from a native format to a text or multimedia message format before transmission to the mobile radio terminal.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a schematic view of a mobile telephone as an exemplary electronic equipment in accordance with an embodiment of the present invention;

FIG. 2 is a schematic block diagram of the relevant portions of the mobile telephone of FIG. 1 in accordance with an embodiment of the present invention;

FIG. 3 is a schematic diagram of a communications system in which the mobile telephone of FIG. 1 may operate; and

FIG. 4 is a diagram showing an exemplary Internet search scheme carried out by components of the communications system in accordance with an embodiment of the present invention.

### DETAILED DESCRIPTION OF EMBODIMENTS

The present invention will now be described with reference to the drawings, wherein like reference numerals are used to refer to like elements throughout.

The term “electronic equipment” includes portable radio communication equipment. The term “portable radio communication equipment,” which herein after is referred to as a “mobile radio terminal,” includes all equipment such as mobile telephones, pagers, communicators, i.e., electronic organizers, personal digital assistants (PDAs), smartphones, portable communication apparatus or the like.

In the present application, the invention is described primarily in the context of a mobile telephone. However, it will be appreciated that the invention is not intended to be limited to a mobile telephone and can be any type of electronic equipment.

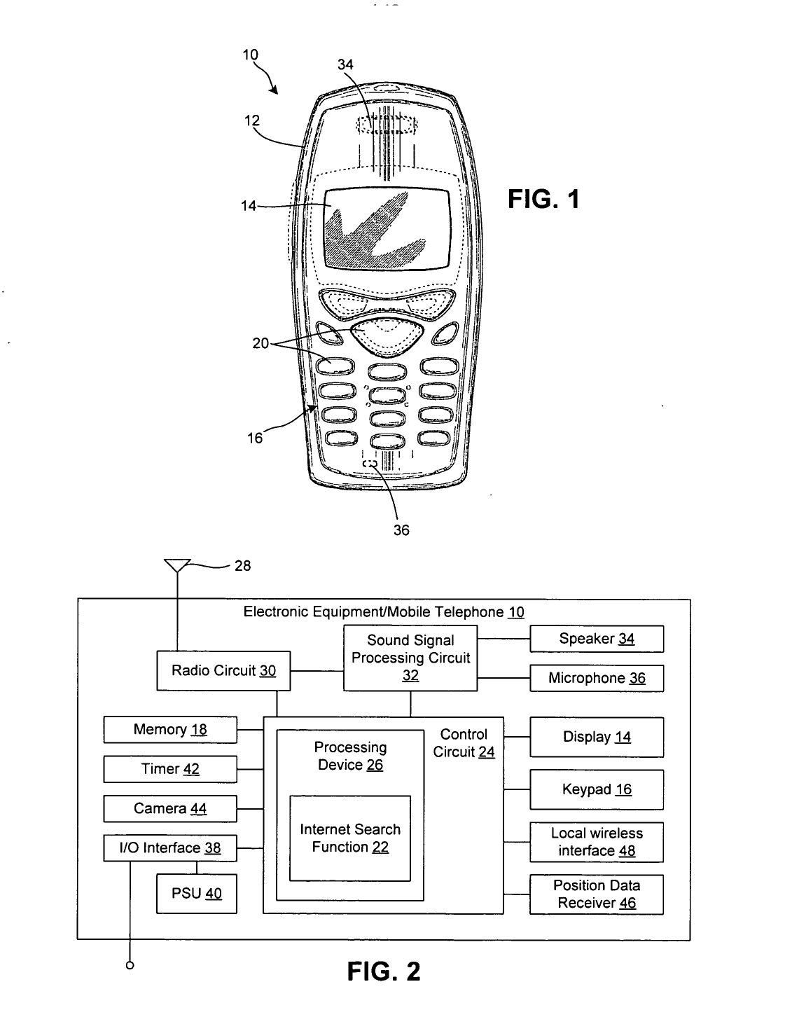

Referring initially to FIG. 1, an electronic equipment 10 is shown in accordance with the present invention. The electronic equipment 10 includes an Internet search function that is configured to assist in carrying out an Internet search and viewing Internet webpage content. It will be appreciated that the Internet search function may be embodied as executable code that may be resident in the electronic equipment 10.

The electronic equipment in the exemplary embodiment is a mobile telephone and will be referred to as the mobile telephone 10. The mobile telephone 10 is shown as having a “brick” or “block” form factor housing 12, but it will be appreciated that other type housings, such as a clamshell housing or a slide-type housing, may be utilized without departing from the scope of the invention.

The mobile telephone 10 includes a display 14 and keypad 16. As is conventional, the display 14 displays information to a user such as operating state, time, telephone numbers, contact information, various navigational menus, etc., which enable the user to utilize the various feature of the mobile telephone 10. The display 14 may also be used to visually display content received by the mobile telephone 10 and/or retrieved from a memory 18 (FIG. 2) of the mobile telephone 10.

Similarly, the keypad 16 may be conventional in that it provides for a variety of user input operations. For example, the keypad 16 typically includes alphanumeric keys 20 for allowing entry of alphanumeric information such as telephone numbers, phone lists, contact information, notes, etc. In addition, the keypad 16 typically includes special function keys such as a “call send” key for initiating or answering a call, and a “call end” key for ending, or “hanging up” a call. Special function keys may also include menu navigation keys, for example, for navigating through a menu displayed on the display 14 to select different telephone functions, profiles, settings, etc., as is conventional. Other keys associated with the mobile telephone may include a volume key, an audio mute key, an on/off power key, a web browser launch key, a camera key, etc. Keys or key-like functionality may also be embodied as a touch screen associated with the display 14.

The mobile telephone 10 includes conventional call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc.

FIG. 2 represents a functional block diagram of the mobile telephone 10. With the exception of an Internet search function 22 according to the present invention, which is preferably implemented as executable logic in the form of application software or code within the mobile telephone 10, the construction of the mobile telephone 10 is otherwise generally conventional. The mobile telephone 10 includes a primary control circuit 24 that is configured to carry out overall control of the functions and operations of the mobile telephone 10. The control circuit 24 may include a processing device 26, such as a CPU, microcontroller or microprocessor. The processing device 26 executes code stored in a memory (not shown) within the control circuit 24 and/or in a separate memory, such as memory 18, in order to carry out conventional operation of the mobile telephone 10. The memory 18 may be, for example, one or more of a buffer, a flash memory, a hard drive, a removable media, a volatile memory, a non-volatile memory or other suitable device. In addition, the processing device 26 executes code in accordance with the present invention in order to perform the Internet search function 22.

It will be apparent to a person having ordinary skill in the art of computer programming, and specifically in applications programming for mobile telephones or other items of electronic equipment, how to program a mobile telephone 10 to operate and carry out the functions described herein. Accordingly, details as to the specific programming code have been left out for sake of brevity. Also, while the Internet search function 22 is executed by the processing device 26 in accordance with the preferred embodiment of the invention, such functionality could also be carried out via dedicated hardware, firmware, software, or combinations thereof, without departing from the scope of the invention.

Continuing to refer to FIGS. 1 and 2, the mobile telephone 10 includes an antenna 28 coupled to a radio circuit 30. The radio circuit 30 includes a radio frequency transmitter and receiver for transmitting and receiving signals via the antenna 28 as is conventional. The radio circuit 30 may be configured to operate in a mobile communications system.

The mobile telephone 10 further includes a sound signal processing circuit 32 for processing audio signals transmitted by/received from the radio circuit 30. Coupled to the sound processing circuit 32 are a speaker 34 and a microphone 36 that enable a user to listen and speak via the mobile telephone 10 as is conventional. The radio circuit 30 and sound processing circuit 32 are each coupled to the control circuit 24 so as to carry out overall operation.

The mobile telephone 10 also includes the aforementioned display 14 and keypad 16 coupled to the control circuit 24. A video decoder (not shown) may be used to convert video data received by the radio circuit 30 or retrieved from a file stored by the memory 18 in to a video signal used to drive the display 14. The mobile telephone 10 may further include any appropriate video and/or audio buffers for buffering video and/or audio data.

The mobile telephone 10 further includes one or more I/O interface(s) 38. The I/O interface(s) 38 may be in the form of typical mobile telephone I/O interfaces and may include one or more electrical connectors. As is typical, the I/O interface(s) 38 may be used to couple the mobile telephone 10 to a battery charger to charge a battery of a power supply unit (PSU) 40 within the mobile telephone 10. In addition, or in the alternative, the I/O interface(s) 38 may serve to connect the mobile telephone 10 to a wired personal hands-free adaptor (not shown). Further, the I/O interface(s) 38 may serve to connect the mobile telephone 10 to a personal computer or other device via a data cable, for example. The mobile telephone 10 may receive operating power via the I/O interface(s) 38 when connected to a vehicle power adapter or an electricity outlet power adapter.

The mobile telephone 10 may also include a timer 42 for carrying out timing functions. Such functions may include timing the durations of calls, generating the content of time and date stamps, etc. The mobile telephone 10 may include a camera 44 for taking digital pictures and/or movies. Image and/or video files corresponding to the pictures and/or movies may be stored in the memory 18. The mobile telephone 10 also may include a position data receiver 46, such as a global positioning system (GPS) receiver, Galileo satellite system receiver or the like. The mobile telephone 10 also may include a local wireless interface 48, such as an infrared transceiver and/or an RF adaptor (e.g., a Bluetooth adaptor), for establishing communication with an accessory, hands-free adaptor, computer or other device.

As indicated, the mobile telephone 10 may be configured to transmit, receive and process data, such as text messages (e.g., in a short message service (SMS) format), multimedia messages (e.g., in a multimedia messaging service (MMS) format), electronic mail messages, image files, video files, audio files, ring tones, streaming audio, streaming video and so forth. Processing such data may include storing the data in the memory 18, executing applications to allow user interaction with data, displaying video and/or image content associated with the data and so forth.

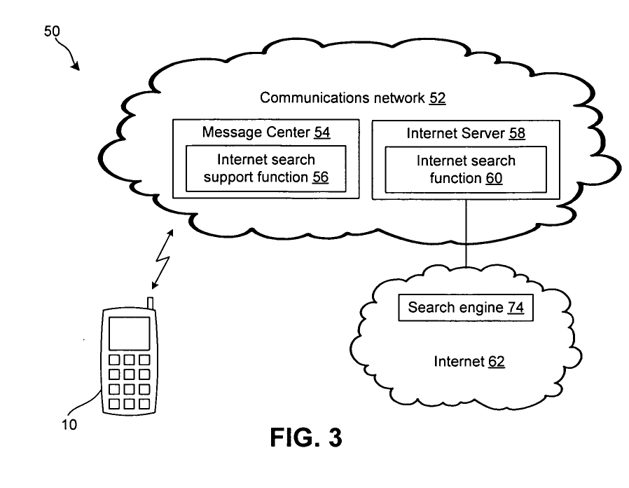

With additional reference to FIG. 3, the mobile telephone 10 may be configured to operate as part of a communications system 50. The system 50 may include a communications network 52 having a server or servers for managing calls placed by and destined to the mobile telephone 10, transmitting data to the mobile telephone 10 and carrying out any other support functions. The servers communicate with the mobile telephone 10 via a transmission medium. The transmission medium may be any appropriate device or assembly, including, for example, a communications tower, another mobile telephone, a wireless access point, a satellite, etc. Portions of the network may include wireless transmission pathways. The network 52 may support the communications activity of multiple mobile telephones 10.

In an example description of the operation of aspects of the present invention that follows, the mobile telephone 10 conducts an Internet search, but does not subscribe to an Internet service offered by the service provider operating the communications network 52. Accordingly, conventional Internet service functions, such as uplinks and downlinks made under WAP may not be available to the mobile telephone 10. The mobile telephone 10, however, may be configured with the Internet search function 22 to facilitate Internet searching without the Internet service subscription.

In one embodiment, the network 52 includes a message center 54. The message center 54 may be a server, which may operate in stand alone configuration relative to other servers of the network 52 or may be configured to carry out the message center functions described herein in combination with other functions, such as Internet server functions. In one embodiment, the message center 54 may carry out the functions of an SMS message center (SMC) that manages text messages received from the mobile telephone 10 and text messages addressed to the mobile telephone 10.

As will be appreciated, the message center 54 may include a processor configured to execute software containing logical instructions that embody the functions of the message center 54 described herein. Some of those functions may be complimentary to the operation of the Internet search function 22 of the mobile telephone 10, and such complimentary functions will be collectively referred to as an Internet search support function 56.

In one embodiment, the network 52 includes an Internet server 58. The Internet server 58 may operate in stand alone configuration relative to other servers of the network 52 or may be configured to carry out the Internet server functions described herein in combination with other functions. In one embodiment, the Internet server may be a WAP Internet server to support WAP Internet services offered by the service operator of the network 52.

As will be appreciated, the Internet server 58 may include a processor configured to execute software containing logical instructions that embody the functions of the Internet server 58 described herein. Some of those functions may be complimentary to the operation of the Internet search support function 56 of the message center 54 and the Internet search function 22 of the mobile telephone 10, and such complimentary functions will be collectively referred to as an Internet search function 60.

The Internet search function 60 of the Internet server 58 may be configured to communicate with an external network, such as the Internet 62, and execute searches over the Internet 62. For instance, the Internet server 58 may include browser functionality that exchanges data with a search engine.

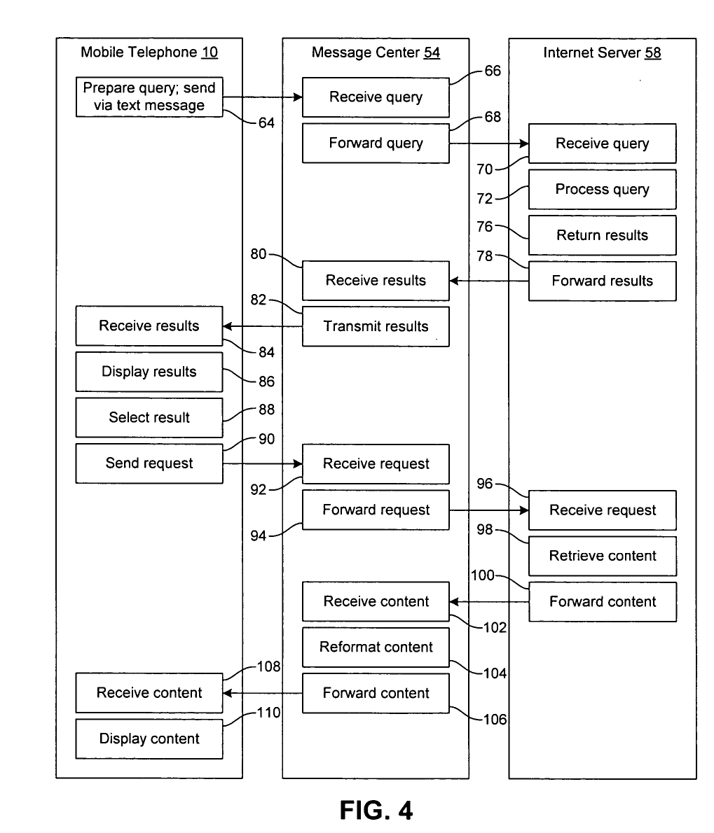

With additional reference to FIG. 4, shown is an exemplary Internet search scheme carried out by components of the communications system 50. The diagram of FIG. 4 shows functional blocks carried out by one of the mobile telephone 10, the message center 54 or the Internet server 58. While not in flow chart format, the functional blocks represented in FIG. 4 may be thought of as depicting steps in a method. As will be appreciated, the illustrated functional blocks may be embodied as software resident in and executed by a corresponding one of the mobile telephone 10, the message center 54 and/or the Internet server 58.

In the example of FIG. 4, the user of the mobile telephone 10 may desire to conduct an Internet search, but does not subscribe to a conventional Internet service. A method of conducting an Internet search without access to a convention Internet service (e.g., a WAP Internet service) with the mobile telephone 10 may begin in block 64.

In block 64, the user may prepare a search query by keying in a search string using an appropriate user interface. The search string may contains words describing the subject of the desired search as one would normally use a WAP Internet browser (e.g., Blazer) or an Internet browser for a personal computer using a conventional Internet connection (e.g., Microsoft's Internet Explorer, Netscape Navigator, Mozilla Firefox, etc.). Once entered, the search string (or query) may be transmitted from the mobile telephone 10 to the message center 54. In one embodiment, the transmitted search string is embodied in a format that does not rely on WAP or other protocol normally used by the communications network 52 to support Internet access for the mobile telephone 10. In the illustrated example, the transmitted search string is formatted as a text message, such as an SMS.

In block 66, the text message is received by the message center 54. Upon receipt of the text message, the message center 54 may forward the query to the Internet server 58 in block 68. If appropriate, the query may be left in the form of an SMS when forwarded to the Internet server 58. In other embodiments, the query may be reformatted. For example, the message center 54 may extract the search string from the payload of the SMS and place the search string in a format expected by the Internet server 58, such as a WAP search inquiry.

In block 70, the query is received by the Internet server 58 for processing. Upon receipt of the query, the Internet server 58 processes the query in block 72 by interacting with an Internet search engine 74 (FIG. 3). The search engine 74 acts upon the query to return a list of search results for the query. The search results may be returned to the Internet server 58 in block 76. The returned search results may be in the form of a list of links to Internet websites or Internet webpages that satisfied the content of the search string. The returned search results may also include passages of text from the Internet webpages that satisfied the search, as might be found using a conventional browser, such as Internet Explorer.

The search results returned in block 76 may be forwarded to the message center 54 in block 78 and received by the message center in block 80. The search results may be transmitted to the message center in the form of one or more text messages (e.g., one or more SMS formatted packets). The content of the text messages may be the uniform resource locator (URL) of the Internet websites or Internet webpages contained in the search results. The URL may be identified by alphanumeric characters without active hypertext links to the corresponding Internet websites or Internet webpages. In another embodiment, the results may be forwarded to the message center 54 in another format, such as hypertext links, WAP formatted packets, etc. In this case, the message center 54 may convert the results received in block 80 into text for transmission to the mobile telephone 10 as described below.

In block 82 the message center 54 may transmit the search results to the mobile telephone 10. The search results transmitted to the mobile telephone 10 may be in text format and transmitted in the form of one or more text messages (e.g., one or more SMS formatted packets). The content of the text messages may be the URL of the Internet websites or Internet webpages contained in the search results, but where the URL(s) is identified by alphanumeric characters without active hypertext links or other content.

The search results may be received by the mobile telephone 10 in block 84. Upon receipt, the search results may be displayed to the user in block 86. In one embodiment, the search results may be displayed to the user as text. For example, each returned result may be displayed as a line of text containing the URL of the corresponding Internet website or Internet webpage. This display technique is well suited for the situation where there is a single search result for display.

In another embodiment, the search results may be displayed to appear as one or more links to Internet websites or Internet webpages. To the user, the links may be presented in similar fashion to the way that a WAP browser would display search results. While the link may appear to be conventional Internet browser links to the user, the displayed links are not supported by underlying conventional Internet protocol linking functions (e.g., the links are not active hypertext links).

Using a user interface generated by the Internet search function 22, the user may select a search result of interest in block 88. The user interface may be configured to allow the user to select a search result of interest in a similar manner to using active links through a WAP browser. For example, the user may scroll through the displayed links and make a selection using an appropriate key 20 of the keypad 16.

The selected search result may be transmitted from the mobile telephone 10 to the message center 54 in block 90 in the form of a request for the content of the corresponding Internet website or Internet webpage. The request may be packaged as a text message, such as an SMS formatted message, containing the URL corresponding to the selected search result.

The request may be received by the message center 54 in block 92. Upon receipt of the request, the request may be forwarded to the Internet server 58 in block 94. In one embodiment, the forwarded request is maintained in the form of a text message. In another embodiment, the content of the request may be reformatted to be consistent with a format expected by the Internet server 58, such as in the form a WAP formatted packet.

The request may be received by the Internet server 58 in block 96. Upon receipt of the request, in block 98, the Internet server 58 may retrieve the content of the Internet website or Internet webpage over the Internet 62 in a conventional manner. The Internet server 58 may format the content for transmission to the message center 54 or the mobile telephone 10. For instance, the content may be formatted for transmission under WAP. In another embodiment, the content may be formatted as text only for transmission in one or more text messages (e.g., an SMS formatted message) or formatted as text and/or graphics for transmission in one or more multimedia messages (e.g., an MMS formatted message). Thereafter, the content may be forwarded to the message center 54 in block 100.

The content may be received by the message center 54 in block 102. If not already in a format for delivery to the mobile telephone 10, the content may be converted from a format received from the Internet server 58 to a format for delivery to the mobile telephone 10 in block 104. For example, the content may be placed into a text format for transmission in one or more text messages (e.g., an SMS formatted message) or into a text and/or graphical format for transmission in one or more multimedia messages (e.g., an MMS formatted message). It is noted that underlying functionality (e.g., hypertext links, scripts, audio and/or visual content, and so forth) of the selected Internet website or Internet webpage may be lost during such a conversion. However, the reformatting places content from the selected Internet website or Internet webpage into a form that may be conveniently transmitted to the mobile telephone 10 using protocols included in the subscription of the mobile telephone 10.

Thereafter, in block 106, the message center 54 may forward the content to the mobile telephone 10. As indicated, the content may be transmitted in one or more SMS or MMS messages. The content may be received by the mobile telephone 10 in block 108. If transmitted in multiple messages, the content may be reassembled by the mobile telephone 10. Upon receipt, and after any reassembly, the mobile telephone 10 may display the content for viewing by the user.

As will be appreciated, the transmissions of blocks 64 and 90 may be considered uplinks and the transmissions of blocks 82 and 106 may be considered downlinks. In the forgoing exemplary embodiment, the uplink (UL) and downlink (DL) data is primarily transmitted as text messages, such as SMS formatted messages. Multimedia messages, such as MMS formatted messages, may also be used for transmitting one or more of the UL and/or DL data. For example, UL and/or DL data may be transmitted as an MMS formatted message over circuit switch data (CSD) or packet switch data (PSD) via a bearer, such as general packet radio service (GPRS), enhanced GPRS (EGPRS), wideband code division access (WCDMA) or high speed downlink packet access (HSDPA).

The Internet search function 22 of the mobile telephone may include browser functionality or work in conjunction with a browser to support a user interface for the above-described method of conducting an Internet search. The browser user interface may assist in presenting a familiar manner of Internet search to the user, even though the UL data and DL data associated with the search is carried out using text and/or multimedia messages falling outside of WAP.

In another embodiment, if the user is aware of a URL for an Internet website or an Internet webpage of interest, the URL may be sent to the message center 54 for retrieval of the corresponding content. In this case, the method may start in block 90 with the transmission of a text message containing the already known URL.

Using the foregoing method, the user of the mobile telephone 10 may search and/or access Internet content without subscribing to an Internet service offered by the operator of the communications network 52, although it is noted that fees may be incurred by sending and/or receiving text or multimedia messages. The service provider operating the communications network 52 may benefit by generating revenue from the text and/or multimedia messages exchanged to carryout the method.

The functionality relating to searching the Internet and supplying content to the mobile telephone 10 may be embodied as the Internet search function 22, the Internet search support function 56 and/or the Internet search function 60. Such functionality may be embodied in any suitable form, including software, firmware, dedicated circuit components, a program or programs stored on computer readable media or machine usable media, and so forth.

Although the illustrations appended hereto that show a specific order of executing functional logic blocks, the order of execution of the blocks may be changed relative to the order shown. Also, two or more blocks shown in succession may be executed concurrently or with partial concurrence. Certain blocks also may be omitted. In addition, any number of commands, state variables, semaphores, or messages may be added to the logical flow for purposes of enhanced utility, accounting, performance, measurement, troubleshooting, and the like. It is understood that all such variations are within the scope of the present invention.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A method of searching the Internet using a mobile radio terminal, comprising:
transmitting a text or multimedia message containing a search query to a server of a communication network providing communication services to the mobile radio terminal;
receiving one or more text or multimedia messages containing the identity of Internet sites satisfying the search query;
selecting one of the identified Internet sites and transmitting a text or multimedia message containing a request for content from the selected Internet site to the server; and
receiving one or more text or multimedia messages containing content from the selected Internet site.

2. The method of claim 1, further comprising displaying the Internet sites satisfying the search query as selectable links.

3. The method of claim 1, further comprising reassembling the content of the selected Internet site and displaying the content for viewing.

4. The method of claim 1, wherein at least one of the search query or the request is sent in a short message service format message.

5. The method of claim 1, wherein the identity of Internet sites satisfying the search query is received in one or more short message service format messages.

6. The method of claim 1, wherein the content is received in one or more multimedia messaging service format messages.

7. The method of claim 1, wherein the content is received in one or more short message service format messages.

8. A program stored on a machine usable medium, the program including an Internet search function executable by a mobile radio terminal, the program comprising executable logic to:
transmit a text or multimedia message containing a search query to a server of a communication network providing communication services to the mobile radio terminal;
receive one or more text or multimedia messages containing the identity of Internet sites satisfying the search query;
select one of the identified Internet sites and transmit a text or multimedia message containing a request for content from the selected Internet site to the server; and
receive one or more text or multimedia messages containing content from the selected Internet site.

9. The program of claim 8, further comprising executable logic to display the Internet sites satisfying the search query as selectable links.

10. The program of claim 8, further comprising executable code to reassemble the content of the selected Internet site and display the content for viewing.

11. A mobile radio terminal, comprising:
a radio circuit for exchanging data with a communications network; and
a processor that executes logic to:
transmit a text or multimedia message containing a search query to a server of the communication network providing communication services to the mobile radio terminal;
receive one or more text or multimedia messages containing the identity of Internet sites satisfying the search query;
select one of the identified Internet sites and transmit a text or multimedia message containing a request for content from the selected Internet site to the server; and
receive one or more text or multimedia messages containing content from the selected Internet site.

12. The mobile radio terminal of claim 11, wherein the processor executes logic to drive a display with the Internet sites satisfying the search query as selectable links.

13. The mobile radio terminal of claim 11, wherein the processor executes logic to reassemble the content of the selected Internet site and drive a display with the content.

14. A method of retrieving content from a particular Internet site using a mobile radio terminal, comprising:
transmitting a text or multimedia message containing a request for the content to a server of a communication network providing communication services to the mobile radio terminal; and
receiving one or more text or multimedia messages containing content from the selected Internet site.

15. A method of providing Internet search support services to a mobile radio terminal, comprising:
receiving a text or multimedia message containing a search query from the mobile radio terminal;
transmitting one or more text or multimedia messages containing the identity of Internet sites satisfying the search query to the mobile radio terminal;
receiving a text or multimedia message containing a request for content from a selected one of the identified Internet sites from the mobile radio terminal; and
transmitting one or more text or multimedia messages containing content from the selected Internet site to the mobile radio terminal.

16. The method of claim 15, further comprising forwarding the search query to an Internet server that carries out processing of the search query and returns the identity of the Internet sites satisfying the search query.

17. The method of claim 15, further comprising reformatting the content from a native format to a text or multimedia message format before transmission to the mobile radio terminal.

18. A communications network server configured to provide Internet search support services to a mobile radio terminal, comprising a processor that executes logic to:
receive a text or multimedia message containing a search query from the mobile radio terminal;
transmit one or more text or multimedia messages containing the identity of Internet sites satisfying the search query to the mobile radio terminal;
receive a text or multimedia message containing a request for content from a selected one of the identified Internet sites from the mobile radio terminal; and
transmit one or more text or multimedia messages containing content from the selected Internet site to the mobile radio terminal.

19. The communications network server of claim 18, wherein the processor executes logic to forward the search query to an Internet server that carries out processing of the search query and returns the identity of the Internet sites satisfying the search query.

20. The communications network server of claim 18, wherein the processor executes logic to reformat the content from a native format to a text or multimedia message format before transmission to the mobile radio terminal.
